(19) United States
(12) Patent Application Publication
(10) Pub. No.: US 2009/0142143 A1
(43) Pub. Date: Jun. 4, 2009

(54) Fly Ash Bentonite Slurry Mixture for Slurry Wall Construction

(76) Inventor: Stanley R. Peters, Castle Rock, CO (US)

Correspondence Address: GLENN L. WEBB;GLENN L. WEBB P.C., P.O BOX 951, CONIFER, CO, 80433, US

(21) Appl. No.: 12/137,190

(22) Filed: Jun. 11, 2008

Related U.S. Application Data
(60) Provisional application No. 60/943,425, filed on Jun. 12, 2007.

(51) Int. Cl. C04B 14/08; E02D 5/18

(52) U.S. Cl. 405/267; 507/145

(57) ABSTRACT

A slurry mixture for use in slurry wall trench construction. The slurry mixture includes fly ash to partially replace bentonite in soil-cement bentonite and soil bentonite cut-off wall construction. A small amount of bentonite is added to the fly ash, water and alluvial material mixture to maintain cohesiveness, prevent settlement and for decreasing permeability of the fly ash.

### RELATED APPLICATIONS

This application relates to provisional application 60943425 filed on Jun. 12, 2007.

### FIELD OF THE INVENTION

This invention relates to slurry mixtures for slurry wall construction.

### BACKGROUND OF THE INVENTION

Slurry wall or slurry trench construction has become increasing popular for creating impermeable groundwater barriers. It has been widely used for creating cut-off walls, reservoir construction, dam and dike construction as well as for providing barriers for ground water treatment systems and any other impermeable groundwater barrier application.

Conventional slurry wall construction is comprised of three separate construction steps. These include excavating a trench, filling the trench as it is being excavated with a slurry mixture to prevent collapse of the trench walls and finally filled with a permanent mixture.

The excavation of the trench is typically done with excavating equipment such as backhoes, clam shell excavators, chain-type trenchers or rotary cutters. Each of these types of equipment have their benefits and detriments. The trencher first digs through alluvial material such as sand and gravel layers and then into bedrock which is much more difficult to excavate. The trenches are typically dug with near vertical walls.

To prevent the collapse of these near vertical walls, the trenches are filled with a high density slurry during the excavation process to hydraulically shore up the trench walls. This slurry is commonly comprised of bentonite and water. The slurry is typically formed either from a remote site and trucked to the trenching operation or else mixed nearby the trenching operation and piped into the trench.

The final step once the trenching excavation is complete is to permanently fill the trench with an impermeable material. This material is typically formed by adding additional bentonite materials with the excavated trench spoils. The trench spoils with slurry are mixed with additional dry bentonite, and pushed in the trench which then stiffens to form the slurry wall backfill. Additional materials such as cement are sometimes added as well for increased strength.

The slurry material is of critical importance. Initially, during the excavation process, the slurry needs to be sufficiently fluid to allow the trencher to operate while having a high density capable of exerting sufficient hydraulic pressure to maintain the integrity of the trench walls to prevent collapse of the trench. Later, after excavation is finished, the trench backfill mixture is pushed into the slurry to form an impermeable barrier to prevent leaching of ground water through the final barrier.

Traditionally, the slurry was mixed remotely and trucked to the excavated trench. In-situ slurry mixing is becoming more popular due to the decrease in equipment and personnel for this type of slurry. In-situ backfill mixing takes advantage of the excavated alluvial and bedrock materials mixed directly with injected slurry in the excavated trench.

Typical slurry materials are Portland cement concrete where the final barrier will form a foundation, a bentonite-cement-soil backfill for “structural” slurry walls or a simple soil-bentonite for water cut-off barriers where no structural strength is needed for geotechnical reasons. Bentonite, a naturally occurring clay, is a historically critical component in most slurry wall construction at least as the slurry component for temporary wall support.

One problem with the currently used slurries is the cost of component materials. Bentonite naturally occurs in limited locations, sodium bentonite mined in an area between South Dakota and Wyoming and calcium bentonite usually in Alabama and Mississippi. It often must be trucked a considerably distance to the trenching site. Thus it has become increasingly important to find a material that will replace some of the bentonite used in slurry wall construction.

Fly ash has been used as an adjunct in Portland cement concrete in small amounts as a partial cement replacement to slow the setting time of the concrete and to lower the costs of the concrete. There are two primary types of fly ash produced at coal-fired power plants as specified in ASTM C 618. These two types are classified according to their chemical composition. Class F fly ash is produced from burning anthracite or bituminous coal. It is rarely cementitious when mixed with water alone and is therefore usually only pozzonlanic (exhibits cementitious properties when reacting with lime or calcium hydroxide from cement hydration). Class F fly ash is essentially inert in the presence of water. Thus, Class F fly ash requires a cementing agent (lime or calcium carbonate) with the presence of water to produce cementitious compounds. Class C fly ash is normally produced from the burning of subbituminous coal and lignite. It exhibits both self-cementitious and pozzonlanic properties due to free lime. Thus Class C fly ash does not require a cementing agent, only water, to form cementitious compounds.

However, fly ash has not previously been considered suitable for use in trenching slurries. First, fly ash mixtures alone do not form an impermeable filter cake that is normally desired in hydraulic barrier/water cut-off barrier slurry walls. Secondly, Type C fly ash has the drawback that it hardens when mixed with water. This makes it unsuitable for slurry wall construction where the slurry may need to remain in a slurry form in the trench for periods up to several days before it is replaced with a final barrier material. Third, Type F fly ash while it is not reactive in water, it tends to quickly settle out of suspension. This quality makes it unsuitable for use alone in trenching slurries.

Another problem with the use of fly ash in ground water barriers is that fly ash can contain significant amounts of heavy metals. Fly ash may contain arsenic, barium, cadmium, chromium, lead, selenium and silver in amounts that could be considered harmful if it leaches into the groundwater. For this reason, the use of fly ash alone in cut-off walls for ground water barriers has not been encouraged.

The present slurry mixes using primarily bentonite are becoming increasingly expensive whereas increased quantities of fly ash are available at little or no cost.

### SUMMARY OF THE INVENTION

The present invention provides a slurry wall mixture that is less expensive, and utilizes waste byproducts of coal-powered electricity generation plants. The slurry wall mixture of the present invention can be used to create slurry walls for maintaining the integrity of the trench wall during excavation as well as forming the final impermeable ground water cut-off barrier.

A preferred embodiment of the present invention uses fly ash as the primary component (not including alluvial materials) of the slurry mixture. A small amount of bentonite is added to the slurry mixture to add cohesiveness to the mixture as well as reducing the permeability of the final barrier. Alluvial and bedrock materials are added to water in the slurry mixture to form the final slurry wall mixture.

In one preferred embodiment, Type F fly ash is used to form a slurry mixture for supporting the trench walls during excavation. The non-reactive nature of the Type F fly ash prevents it from hardening too quickly during the excavation process. A small amount of bentonite is added to reduce the occurrence of settlement before the slurry is hardened and to “gel” the slurry and to improve the creation of filter cake on the trench walls. This slurry may be mixed in-situ or for use with bucket excavated alluvial materials. A small amount of lime may be added along with additional alluvial materials during in-situ applications to cause the Type F fly ash to become cementious for the final barrier. The small amount of bentonite will also improve the impermeability of the fly ash in the final barrier as well as minimize the leaching of any heavy metals that may be present in the fly ash. These heavy metals are diluted by mixing with alluvial materials and then encapsulated by the bentonite which lessens the migration of water through the mixture. The amount of lime may be eliminated or reduced to form a non-hardening Type F fly ash-bentonite-soil mixture that will remain pliable and “self-healing” to lateral loads, such as earthquakes or disturbances.

Another preferred embodiment of the present invention uses Type C fly ash for a slurry mixture for the final barrier in an in-situ mixed trench wall construction. The self-cementious nature of the Type C fly ash will cause the slurry to harden into the final barrier. A small amount of bentonite is added to the slurry mixture to provide cohesiveness, “gel” the mixture, decrease permeability of the fly ash and to minimize leaching of heavy metals from the fly ash.

These and other features of the present invention will be evident from the ensuing detailed description of preferred embodiments and from the claims.

### DETAILED DESCRIPTION OF PREFERRED EMBODIMENTS

The present invention provides a slurry material that is effective for slurry wall construction. It is to be expressly understood that this exemplary embodiment is provided for descriptive purposes only and is not meant to unduly limit the scope of the present inventive concept. Other embodiments of the products and methods of use of the present invention are considered within the present inventive concept as set forth in the claims herein. For explanatory purposes only, the products and methods of use of the preferred embodiments are discussed primarily for the purposes of understanding the present invention. It is to be expressly understood that other products and methods are contemplated for use with the present invention as well.

Initially, during the excavation process, the slurry needs to be sufficiently fluid to allow the trencher to operate while having a high density capable of exerting sufficient hydraulic pressure to maintain the integrity of the trench walls to prevent collapse of the trench. Later, after the final backfill mixture is placed, the trench backfill stiffens to form an impermeable barrier to prevent migration of ground water through the barrier. So two critical characteristics of a competent slurry mix is that it is initially fluid while maintaining a high density over a period of time that may extend to several days; and become impermeable when incorporated into the final backfill mixture.

The present invention, in a preferred embodiment, provides an effective slurry for slurry wall trench construction. The slurry of this preferred embodiment uses a partial replacement of fly ash for bentonite for slurry wall construction. This partial replacement is much lower cost than bentonite and uses a byproduct of coal-powered electric plants. The preferred embodiment of the present invention uses Type C and Type F fly ash as a partial replacement for bentonite, depending on the type of slurry wall construction technique.

In one preferred embodiment, the present invention uses Type C fly ash as a partial replacement of bentonite in soil-cement-bentonite or soil-bentonite slurry wall construction for water cut-off barriers. The self-cementious properties of Type C fly ash generates considerable strength for the slurry wall in lieu of cement. In the preferred embodiment, the Type C fly ash is particularly advantageous for use with in-situ mixed trenching equipment. A small amount of bentonite is mixed as well but in less quantity than in the previous slurry mixes. The small amount of bentonite makes the slurry more cohesive and reduces the permeability of the final cut-off wall.

The mixture of Type C fly ash and bentonite provides a cost-effective high density fluid when in-situ mixed with the alluvial and bedrock materials excavated during the trenching process for the final barrier. The fly ash will fill in the voids in the alluvial material as well as bind the materials as it becomes cementious. The bentonite will greatly swell up to fill voids in the excavated materials and to fill the trench along with the fly ash. The small amount of bentonite will also work with the alluvial materials to lessen the permeability of the fly ash.

The slurry mixture of this preferred embodiment uses bentonite to Type C fly ash in the range of 10% to 50% by weight, and preferably in the range of around 33% by weight of the Type C fly ash. The fly ash is in a fine powder form so it mixes with water and fills the voids of the alluvial and bedrock mixtures. This further adds to the impermeability of the final barrier once the fly ash becomes cementious. The fly ash becomes an inert filler in the barrier and greatly reduces the amount of bentonite necessary for the barrier. Bentonite powder is typically used to flow into the voids and is becoming increasingly more expensive. Fly ash is able to replace much of the bentonite powder previously used.

In another preferred embodiment of the present invention uses Type F fly ash to create the high-density trenching fluid to support the trench walls during the excavation process during the construction of hydraulic barrier slurry walls. The Type F fly ash is readily mixed with on-site water to obtain the desired slurry properties (density and viscosity). Relatively small amounts of bentonite may be added to “gel” the slurry, to reduce the normal settlement of the non-reactive Type F fly ash as well to improve the creation of filter cake on the trench walls. Viscosity-modifying admixtures and/or recirculating pumps for the trench fluids may also be used to prevent the Type F fly ash from settling out of suspension.

The Type F fly ash is suitable for use with traditional bucket-excavated, site mixed slurry backfill where the alluvial materials are removed from the trenching site, mixed with a small amount of bentonite. This mixture is then returned to the excavated trench to provide the final barrier.

The Type F fly ash is also suitable for use with in-situ trenching equipment as well. Once the trenching is complete, the mixture of Type F fly ash, bentonite, bedrock and alluvial materials may be treated with additional amounts of bentonite, lime and/or cement to form the final barrier. The lime will activate the pozzolanic properties of the Type F fly ash and stiffen the mixture.

The slurry mixture of this preferred embodiment uses bentonite to Type F fly ash in the range of 10% to 50% by weight, and preferably in the range of around 33% by weight of the Type F fly ash. If the slurry mixture is to be used for the final barrier, then an amount of lime, in a preferred embodiment, is between 2% to 6% by weight of the Type F fly ash is added to activate the pozzolanic properties of the Type F fly ash.

In another alternative embodiment, the Type F fly ash mixture is not treated with lime. The slurry forms a pliable, self-healing barrier that can withstand earthquakes and other disturbances.

The bentonite in combination with the large amount of inert alluvial material act to minimize any leaching of heavy metals of the fly ash into the groundwater. The large amount of inert alluvial material and bentonite dilutes the amount of heavy metals in the fly ash. Further, and more importantly, the bentonite reduces the permeability of the fly ash to lessen the ability of heavy metals to leach from the fly ash into the ground water, since the ground water cannot readily flow through the hardened mixture of fly ash and alluvial materials. It is also believed that bentonite contains properties of binding and ionic surfaces to coat and bind the fly ash to prevent leaching of the heavy metals.

The preferred embodiments described herein are intended for descriptive purposes only and are not meant to limit the scope of the claimed invention.

What is claimed is:

1. A slurry mixture for slurry wall trench construction, the slurry mixture comprises:
fly ash;
bentonite in the range of ten percent to ninety percent by weight of the fly ash;
alluvial materials; and
water.

2. The slurry mixture of claim 1 wherein said bentonite material includes:
bentonite in the range of ten to fifty percent by weight of the fly ash.

3. The slurry mixture of claim 1 wherein said fly ash includes:
Type C fly ash for in-situ backfill mixtures.

4. The slurry mixture of claim 1 wherein said fly ash includes:
Type F fly ash for excavated backfill mixtures and in-situ backfill mixtures.

5. The slurry mixture of claim 1 wherein said slurry mixture further includes:
Type F fly ash; and
lime in an amount in the range of two to six percent by weight of the fly ash.

6. The slurry mixture of claim 1 wherein said slurry mixture comprises:
in-situ mixing of said fly ash, bentonite, alluvial and bedrock materials obtained from a trenching site.

7. The slurry mixture of claim 1 wherein said slurry mixture comprises:
said fly ash is Type F fly ash; and
mixing said fly ash, bentonite, and water are mixed with alluvial materials excavated from a trenching site and returned to the site of the trench during excavation.

8. The slurry mixture of claim 1 wherein said slurry mixture comprises:
Type F fly ash for forming a slurry for supporting trench walls during excavation.

9. The slurry mixture of claim 1 wherein said slurry mixture comprises:
Type F fly ash for forming a final ground water cut-off barrier; and
lime for activating the pozzolanic properties of the Type F fly ash.

10. The slurry mixture of claim 1 wherein said slurry mixture comprises:
Type C fly ash for forming an in-situ mixed final groundwater cut-barrier.

11. A method for slurry wall construction for ground water barriers, said method comprising:
excavating a trench;
forming an in-situ slurry mixture of fly ash, bentonite, water and alluvial and bedrock materials; and
allowing said slurry mixture to stiffen into an impermeable barrier.

12. The method of claim 11 wherein said step of forming the slurry mixture includes the step of:
providing the bentonite in an amount of between ten to fifty percent by weight of the fly ash.

13. The method of claim 11 wherein said step of forming the slurry mixture includes the step of:
providing Type F fly ash.

14. The method of claim 11 wherein said step of forming the slurry mixture includes the step of:
providing Type F fly ash; and
providing lime in the range of 2-6 percent by weight of the fly ash.

15. The method of claim 11 wherein said step of forming the slurry mixture includes the step of:
providing Type C fly ash.

16. The method of claim 11 wherein said method comprises the step of:
forming the mixture in-situ in the excavated trench.
